(19) United States
(12) Patent Application Publication
(10) Pub. No.: US 2023/0139026 A1
(43) Pub. Date: May 4, 2023

(54) FAST HARDENING AQUEOUS COATING COMPOSITIONS CONTAINING GRAFT COPOLYMER OF POLYAMINE AND VINYL MONOMERS

(71) Applicant: Arkema Inc., King of Prussia, PA (US)

(72) Inventors: Donovan K. LUJAN, King of Prussia, PA (US); Jeremy L. GROVE, King of Prussia, PA (US); Wenjun WU, King of Prussia, PA (US); Jeffrey A. SCHNEIDER, King of Prussia, PA (US)

(21) Appl. No.: 17/918,131

(22) PCT Filed: Apr. 15, 2021
(86) PCT No.: PCT/US2021/027462

§ 371 Date: Oct. 11, 2022

Related U.S. Application Data
(60) Provisional application No. 63/010,786, filed on Apr. 16, 2020.

(51) Int. Cl. C09D 133/24; C09D 133/12; C09D 5/02; C09D 151/08

(52) U.S. Cl. CPC C09D 133/24; C09D 133/12; C09D 5/024; C09D 151/08

(57) ABSTRACT

An anionically-stabilized aqueous emulsion composition includes a) a first emulsion polymer having a Tg from −60° C. to 40° C.; b) a volatile base; and c) polymeric particles, different from the first emulsion polymer and present in emulsified form. The c) polymeric particles are polyamine graft copolymers, in which vinyl monomers form a polymer grafted to a water-soluble amino-group containing polymer. The anionically-stabilized aqueous emulsion composition may have a pH of from 8 to 11.

### FIELD OF THE INVENTION

This invention relates generally to aqueous compositions used as coatings, inks, adhesives, and the like that incorporate particles of a polyamine graft copolymer present in the composition in emulsified form. More specifically, this invention relates to anionically-stabilized aqueous compositions containing emulsion polymer dispersions that include these polyamine graft copolymers, emulsion polymers, and a volatile base.

### BACKGROUND OF THE INVENTION

Latex products are widely used in a variety of coatings, adhesives, and inks because of the ease in which they can be handled and the absence of any substantial amount of volatile organic compounds (VOCs). One example of such a latex product is an acrylic latex composition used in traffic marking paints. Due to the market demand for products that exhibit a shortened setting time, the coatings industry has widely adopted coagulation technology for use in latex products intended for traffic marking paints. Within the confines of such coagulation technology, protonated polyfunctional amines de-stabilize the anionically-stabilized latex particles present in the latex products after they are coated onto a substrate. Such anionically-stabilized emulsion compositions typically comprise three elements.

The first element is an anionically-stabilized aqueous emulsion polymer, which is stable during storage at certain high pH's. The emulsion polymer may comprise, as polymerized monomers, carboxylic-acid functionalized monomer, such as acrylic acid or methacrylic acid, which is neutralized, and therefore negatively charged, at high pH. Likewise, any amine-functional monomer incorporated into the emulsion polymer is uncharged due to high pH. These emulsions may have a solids content of from 40-70% by weight. This aqueous emulsion polymer comprises at least one anionic surfactant.

The second element of these fast-dry compositions is a volatile base incorporated at a level to achieve a targeted high pH. Ammonia is the preferred volatile base for this purpose. The purpose of the ammonia or other volatile amine is to increase the pH of the coating composition to a level that prevents the protonation of the polyfunctional amine added as a fast-dry additive, during preparation and storage of the fast-dry composition.

The third element is fast-dry additive, which may be added at from 0.01 to 10 weight % based on the polymer solids on a dry basis. The fast-dry additive type commonly employed is a water-soluble polyamine, which is relatively uncharged or deprotonated at the high pH during storage. As this species is uncharged, it does not cause coagulation of the anionically-stabilized emulsion polymers.

When the latex product is applied onto a substrate, at least a portion of the volatile amine evaporates from the applied coating composition. This loss of volatile amine results in a decrease in the pH of the applied latex coating composition. The decrease in pH triggers the protonation of the polyamine fast-dry additive, which then interacts with the negatively-charged emulsion polymer and results in coagulation, i.e., de-stabilizing of the latex particles in the applied coating composition. This results in the fast-setting of the coating. However, the high pH, usually 10 or higher, required to prevent premature coagulation of these latexes during storage, is not desirable due to the odor of the volatile base. Accordingly, there is a need for a solution to reduce the required pH and odor while retaining storage stability of the latex and fast-dry performance.

Generally, the necessary amount of the polyfunctional amine may depend on total amine content in the polyfunctional amine and the relative molar percentages of primary, secondary, and tertiary amines on the polyfunctional amine.

Other workers' efforts to produce polyfunctional amines are illustrated in the following documents.

U.S. Pat. No. 5,527,853 describes aqueous coating compositions containing an anionically-stabilized polymer, polyfunctional amines, and a volatile base. The polyfunctional amines comprises random copolymers.

U.S. Pat. No. 5,804,627 describes aqueous coating compositions containing an anionically-stabilized polymer, polyfunctional amines, and a volatile base. The polyfunctional amines comprises random copolymers.

U.S. Pat. No. 6,075,079 describes aqueous coating compositions comprising an anionically-stabilized polymer, polyethylenimine, and a volatile base.

U.S. Pat. No. 6,573,313 describes grafted amphiphilic latex nanoparticles comprising a core and shell. They are not disclosed to be useful in coating compositions.

U.S. Pub. 2015/0259559 describes aqueous coating compositions containing an anionically-stabilized polymer, one or more N-derivatized polyamines, and a volatile base.

U.S. Pub. 2015/0259559 aqueous coating compositions containing an anionically-stabilized polymer, one or more derivatives of polyamines, and a volatile base. The derivatives of polyamines may be, for example, alkoxylated polyamines.

U.S. Pub 2016/208129 describes polyfunctional amine structures exhibiting at least one hydrophobic moiety selected from the group consisting of; hydrophobic epoxides, hydrophobic glycidyl ethers and hydrophobic(meth)acrylates. The polyfunctional amines are modified with the hydrophobic moieties by a condensation reaction at a —NH or —NH₂ site. The modified PEI examples in this publication are quite low in molecular weight—less than 1000 Da.

WO 2016/16118221 describes aqueous coating compositions containing an anionically-stabilized polymer, modified polyfunctional amines, and a volatile base. The polyfunctional amines are modified by the addition reaction of a hydrophobic moiety at a —NH or —NH₂ site, which is not amenable to the formation of high weight average molecular weight polymers.

J. Zhu et al. in Bioconjugate Chem., 2005, 16, 139-146 discloses Amphiphilic Core-Shell Nanoparticles with Poly(ethylenimine) shells as potential gene delivery carriers. No mention is made of the suitability of the particles for use in fast-dry anionically-stabilized coating compositions.

P. Sunintaboon et al. in Colloids and Surfaces A: Physicochem. Eng. Aspects, 350 (2009) 114-120 describes modification of sulphur-prevulcanized natural rubber (SPNR) sheet with poly(methyl methacrylate) (PMMA) colloidal nanoparticles without pre-treatment of the rubber. The particles are not disclosed to be useful in anionically-stabilized coating compositions.

S. Inphonlek, et al., in Colloids and Surfaces B: Biointerfaces, 77 (2010) 219-226 describes synthesis of poly(methyl methacrylate) core/chitosan-mixed-polyethyleneimine shell nanoparticles and their antibacterial properties. The particles are not disclosed to be useful in anionically-stabilized coating compositions.

A. Wu, et al. in Colloids and Surfaces A: Physicochem. Eng. Aspects, 384 (2011) 180-185 describes amphiphilic PMMA/PEI core—shell nanoparticles useful as polymeric adsorbents to remove heavy metal pollutants. The particles are not disclosed to be useful in fast-dry anionically-stabilized coating compositions.

J. Kook, et al., in Advances in Materials Physics and Chemistry, 2016, 6, 220-229 describes methods of preparing grafted PMMA/PEI (polymethylmethacrylate/polyethyleneimine) core-shell nanoparticles prepared by soap free emulsion polymerization. The particles are not disclosed to be suitable for use in fast-dry anionically-stabilized coating compositions.

### SUMMARY OF THE INVENTION

The inventors have found that the addition of relatively small amounts of polyamine graft copolymers, in which vinyl monomers are grafted to a polyamine, allows for reduced pH needed to maintain storage stability of anionically-stabilized aqueous emulsion compositions, as compared to similar anionically-stabilized aqueous emulsion compositions comprising conventional polyethyleneimine-type fast-dry additives. The polyamine graft copolymers disclosed herein are prepared using a free-radical grafting method and are present in the anionically-stabilized aqueous emulsion compositions as a dispersion. More specifically, these graft copolymers are prepared by free-radical grafting of vinylic monomers onto a polyamine. Thus, the structure of these graft copolymers formed via a free-radical polymerization grafting reaction are fundamentally different from such polyamines that are functionalized with a similar moiety via a condensation reaction. The condensation reactions may place only one such hydrophobic moiety at an NH or NH₂ functionality on the polyamine, but when grafting via the free radical method as utilized herein, the vinylic hydrophobic monomers themselves are polymerized at the grafting site of the polyamine. FIG. 1 of J. Kook, et al., in Advances in Materials Physics and Chemistry, 2016, 6, 220-229, the disclosure of which is incorporated by reference in its entirety for all purposes, illustrates the nature of the free radical graft polyamines disclosed herein.

The free radical grafting of vinylic monomers onto the polyamine results in decreased level of primary amines and thus a reduction in the amount of highly basic amines. This translates to a lower degree of protonation at a given pH, therefore allowing a more stable emulsion composition at a lower pH. The reduced pH level means that less volatile base needs to be incorporated into anionically-stabilized aqueous emulsion compositions, which provides economic, technical, environmental, health and safety benefits.

Accordingly, an anionically-stabilized aqueous emulsion composition is provided. The composition comprises, consists of, or consists essentially of:

a) a first emulsion polymer present in the aqueous emulsion composition in emulsified form, the first emulsion polymer comprising, as polymerized units, at least one monoethylenically-unsaturated monomer, the first emulsion polymer having a Tg from −60° C. to 40° C.;

b) a volatile base; and

c) a polyamine graft copolymer different from the first emulsion polymer and comprising, as polymerized units, vinyl monomers grafted to a water-soluble amino-group containing polymer.

The anionically-stabilized aqueous emulsion composition has a pH of from 8 to 11, and the c) polyamine graft copolymer is present in an amount effective to de-stabilize the aqueous emulsion composition upon evaporation of at least a portion of the volatile base while maintaining the stability of anionically-stabilized aqueous emulsion composition during preparation and storage.

These compositions are especially useful in the area of traffic paints. Further areas of applicability will become apparent from the description provided herein. For example, the latex products made and used according to the teachings contained herein are described throughout the present disclosure in conjunction with a traffic marking paint in order to more fully illustrate the composition and the use thereof. The incorporation and use of such latex products as a coating in other applications, such as roof coatings, inks, paints, adhesives, caulks, sealants, mastics, or the like are contemplated to be within the scope of the present disclosure.

### DETAILED DESCRIPTION

The following description is exemplary in nature and is in no way intended to limit the present disclosure or its application or uses. It should be understood that throughout the description, corresponding reference numerals indicate like or corresponding parts and features.

Unless otherwise indicated, all percentages herein are weight percentages.

“Polymer” as used herein, is meant to include organic molecules with a weight average molecular weight higher than 1,000 Da, or higher than 1,500 Da, or higher than 2,000 Da, or higher than 2,500 Da, or higher than or 5,000 Da, or higher than 50,000 Da or higher than 100,000 Da or higher than 200,000 Da as measured by gel permeation chromatography using tetrahydrofuran as solvent and polystyrene of known molecular weights as calibration standards. All polymer molecular weights unless stated otherwise are recited as weight average molecular weight (Mw).

The terms “paint” and “coating” as used herein may be considered to be interchangeable.

Glass transition temperature is measured using differential scanning calorimetry in accordance with ATSM-D3418-15 (2018) using a standard heating rate of 10° C./min.

The present disclosure generally provides an anionically-stabilized aqueous emulsion composition comprising the following three components: The first component a) is a first emulsion polymer present in the aqueous emulsion composition in emulsified form. The first emulsion polymer comprises, as polymerized units, at least one monoethylenically-unsaturated monomer. The second component b) is a volatile base. The third component c) comprises a polyamine graft copolymer that is different from the first emulsion polymer and comprises, as polymerized units, vinyl monomers grafted to a water-soluble amino-group containing polymer. This polyamine graft copolymer comprising vinyl monomer grafted polyamine copolymers may be present in the aqueous emulsion composition in emulsion form, i.e., the polyamine free radical graft copolymer may be present as a dispersion in the anionically-stabilized aqueous emulsion composition. The polyamine free radical graft copolymer may be present in the emulsion in the form of polymeric particles that may have a size, as measured by dynamic light scattering, of from 50-400 nm. The polyamine free radical graft copolymer may be in the form of core-shell particles in which the core comprises the vinyl monomers as the polymerized units and the shell comprises the water-soluble amino group containing polymer. The form of these particles is described in U.S. Pat. No. 6,573,313, the entire disclosure of which is incorporated by reference herein for all purposes.

### Vinyl Monomer Free Radical Grafted Polyamine Copolymers

The graft copolymers are prepared by free-radical addition polymerization of at least one vinyl monomer onto a water-soluble amino-group containing polymer. These are prepared via an aqueous graft copolymerization of the at least one vinyl monomer onto an amino group-containing water-soluble polymer. The water-soluble amino-group containing polymers may be selected from biopolymers and synthetic polymers. In this process, free radicals may be generated with a free radical initiator that may interact with a nitrogen atom on an amino group of the water-soluble polymer. This free radical on an amino group of the water-soluble polymer then may initiate the free-radical polymerization of the at least one monoethylenically-unsaturated monomer to produce the graft copolymers. Non-limiting examples of such free radical initiators are alkyl hydroperoxides (ROOH) or other catalysts or free radical initiators as are known and used in the art. A preferred alkyl hydroperoxide is tertiary-butyl hydroperoxide (tBHP). The vinyl monomer grafted polyamine copolymers may be present as a dispersion of particles in the anionically-stabilized aqueous emulsion composition, i.e. the graft copolymer as disclosed herein is not water soluble. If present as a dispersion of particles, the particles are not hollow or voided, and the inside of the particles may comprise the polymerized vinyl monomers which are grafted to the polyamine. The polyamine may be water dispersible or water-soluble. Without wishing to be bound by theory, when present in the anionically-stabilized aqueous emulsion composition, such particles may be in the form of core-shell particles such that the interior, i.e., the core, comprises the hydrophobic polymerized vinyl monomers and the outside, i.e., the shell, is comprised of the water dispersible or water soluble polyamine. The size of these particles may be from 50 nm to 400 nm, as measured by dynamic light scattering.

When the pH of the anionically-stabilized aqueous emulsion composition is at a high enough pH, the polyamine free radical graft copolymer is relatively uncharged. The emulsion polymers in the anionically-stabilized aqueous emulsion composition have a negative charge and therefore repel each other electrostatically. When the pH drops due to the evaporation of at least a portion of a volatile base, such as ammonia, the polyamine free radical graft copolymer becomes protonated and thus attracts the negative emulsion particles in the composition and the particles then coagulate/flocculate. This coagulation is desirable when the anionically-stabilized aqueous emulsion composition is applied to a substrate, but is undesirable during preparation and storage of the anionically-stabilized aqueous emulsion composition. Accordingly, the polyamine free radical graft copolymer is present at a level to initiate coagulation when the emulsion is applied to substrate and at least a portion of the volatile base evaporate; however, without destabilizing the emulsion composition during preparation and storage.

### Vinyl Monomer for the Polyamine Graft Copolymers

The polyamine graft copolymers are prepared by free-radical addition polymerization or grafting of at least one vinyl monomer onto a water-soluble amino-group containing polymer. Suitable vinyl monomers that may be used to produce the polyamine free radical graft copolymers are not particularly limited. U.S. Pat. No. 6,573,313, the disclosure of which is incorporated herein in its entirety for all purposes, provides suitable vinyl comonomers that may be utilized in the preparation to the graft copolymers disclosed herein. Non-limiting examples of the at least one vinyl monomer include vinyl aromatic monomers such as styrene, α-methyl styrene, p-methyl styrene, t-butyl styrene, or vinyltoluene, olefins such as ethylene, vinyl acetate, vinyl chloride, vinylidene chloride, (meth)acrylonitrile, (meth)acrylamide, (C1-C20) alkyl or (C3-C20) alkenyl esters of (meth)acrylic acid, such as methyl (meth)acrylate, ethyl (meth)acrylate, butyl (meth)acrylate, 2 ethylhexyl (meth)acrylate, hydroxyethyl(meth)acrylate, hydroxypropyl(meth)acrylate, benzyl (meth)acrylate, lauryl (meth)acrylate, oleyl (meth)acrylate, palmityl (meth)acrylate, stearyl (meth)acrylate and the like, vinyl acetate and the like, and mixtures thereof are all suitable. The vinyl monomers that may be used to produce the polyamine graft copolymers may be selected from alkyl (meth)acrylates, C2-C4 olefins, aromatic olefins, conjugated dienes, vinyl monomers, and mixtures thereof. The monoethylenically-unsaturated monomers that may be used to produce the polyamine graft copolymers may be selected, in certain embodiments, from methyl acrylate, methyl methacrylate, butyl acrylate, butyl methacrylate, styrene, a-methyl styrene, divinyl benzene, butadiene, ethylene, vinyl acetate, vinyl versatate, vinyl chloride, 2-ethylhexyl acrylate, and mixtures thereof. Preferred examples of such vinyl monomers include methyl methacrylate, butyl acrylate, ethyl acrylate, methyl acrylate, 2-ethylhexyl acrylate, and styrene. More preferred examples include methyl methacrylate and butyl acrylate.

The weight average molecular weight of these graft copolymers may be from 2,000 to 100,000 Da, or may be from 2,500 to 60,000 Da, or 3,000 to 50,000 Da, or 2,500 to 30,000 Da, or 3,500 to 25,000 Da, or greater than 25,000, or greater than 50,000, or greater than 75,000 Da.

### Water-Soluble Amino-Group Containing Polymer

Non-limiting examples of suitable water-soluble amino-group containing polymers that may be used to produce the graft copolymers are polyamines, polyimines, polyethylenimine, chitosan, N-acetyl sugars, casein, gelatin, albumin or other proteins, or mixtures thereof. Polyethyleneimine (PEI) is preferred. U.S. Pat. No. 6,573,313 provides a list of suitable water-soluble amino-group containing polymers. The water-soluble amino-group containing polymers may be branched, or straight-chained, or may be dendrimeric. The weight average molecular weight of these amino-group containing polymers may range from 700 Da or higher. For example the water-soluble amino-group containing polymer may have a weight average molecular weight in Da higher than 2,000 or higher than 2,500 or higher than 3,000 or higher than 3,500 or higher than 4,000 or higher than 5,000 or higher than 6,000 or higher than 7,500 or higher than 10,000 or higher than 13,000 or higher than 20,000, or higher than 50,000 or higher than 100,000 Da. The weight average molecular weight may be from 2,000 to 100,000 Da or from 2,500 to 50,000 Da or from 3000 to 75,000 Da or from 2,000 to 13,000 Da or from 2,500 to 25,000 Da or from 3,000 to 30,000 Da or from 10,000 to 25,000 Da or from 15,000 to 50,000 Da or from 2500 to 5000 Da or from 13,000 to 20,000 Da or from 15,000 to 40,000 Da or from 25,000 to 35,000 Da or from 25,000 to 50,000 Da or from 25,000 to 35,000 Da or from 2500 to 3000 Da or from 5500 to 10,000 Da or from 25,000 to 60,000 Da. The polyamine graft copolymers may comprise from 5% to 90% by weight on a dry basis of the water-soluble amino-group containing polymer. The polyamine graft copolymers may comprise from 10% to 50% or from 15% to 40% or from 15% to 25% by weight on a dry basis of the water-soluble amino-group containing polymer. The particle size of the polyamine graft copolymer may be from 50 nm to 400 nm, preferably, 50 to 250 nm, measured using a dynamic light scattering instrument, for example, Nanotrac Particle Size Analyzer UPA 150 from Microtrac.

The amount of the polyamine graft copolymer in the anionically-stabilized aqueous composition may be from 0.01 weight percent to 10 weight percent of the total dried weight of the a) first emulsion polymer. The polyamine graft copolymers in the anionically-stabilized composition may be from 0.01 weight percent to 5 weight percent of the total dried weight of the a) first emulsion polymer. A preferred range is from 0.25 to 3.0 weight percent of the total dried weight of the a) first emulsion polymer. Other preferred ranges are from 0.1 to 5.0 weight percent or from 0.5 to 4 weight percent of the total dried weight of the a) first emulsion polymer.

Even though water-soluble polyamines such as non-grafted polyethyleneimine may be included in such anionically-stabilized aqueous emulsion compositions, when the non-grafted polyamine is incorporated in the anionically-stabilized aqueous compositions, the pH of the composition must be maintained at a higher pH than when the polyamine free radical graft copolymers are incorporated.

### pH of Anionically-Stabilized Aqueous Emulsion Composition:

The anionically-stabilized aqueous emulsion composition may have a pH of from 8 to 11. The pH of the anionically-stabilized aqueous emulsion composition may have a pH of from 9 to 11, or from 9 to 10, or 9 to 10.5, measured by a calibrated pH meter.

### Volatile Base:

Suitable non-limiting examples of volatile bases are: ammonium hydroxide (i.e., an aqueous solution of ammonia), ammonia, trimethylamine, triethylamine, dimethylethanol amine, aminopropanol, 2-amino-2-methyl-1-propanol, morpholine, n-methyl morpholine, precursors thereof, and mixtures thereof may be used as the volatile base. Preferred examples of volatile bases include ammonium hydroxide (an aqueous solution of ammonia), trimethylamine, triethylamine. More preferred is ammonium hydroxide, which is an aqueous solution of ammonia.

The amount of volatile base in the anionically-stabilized emulsion composition may be adjusted according to the desired final pH of the aqueous emulsion composition.

### First Emulsion Polymer a)

Emulsion polymers and monomers useful to prepare polymeric emulsions or dispersions are known in the art (as described in texts on the subject such as “Emulsion Polymerization: Theory and Practice” by D. C. Blackley published by Wiley in 1975, “Emulsion Polymerization” by F. A. Bovey et al. published by Interscience Publishers in 1965, and “Emulsion Polymerization and Emulsion Polymers” by P. A. Lovell et al. published by Wiley Science in 1997) the entire disclosures of which are incorporated by reference herein for all purposes.

The polyamine graft copolymers of the present invention are useful in waterborne coating compositions comprising a wide variety of polymers, which include but are not limited to: various vinyl polymers, such as polyvinyl chloride and copolymers thereof, poly(vinyl acetate) and copolymers thereof; vinyl acetate ethylene copolymers, various polyacrylates and copolymers thereof (e.g., polymers prepared from monomers such as methyl (meth)acrylate, ethyl (meth)acrylate, butyl (meth)acrylate, cyclohexyl (meth)acrylate, allyl methacrylate, 2-ethylhexyl acrylate; various acrylic acids such as methacrylic acid, acrylic acid, itaconic acid, etc.), and various esters of versatic acid and copolymers; polystyrene and styrenated acrylic polymers (e.g., polymers of styrene and/or alpha-methyl styrene and copolymers of styrene and/or alpha-methyl styrene with alkyl (meth)acrylate and acid monomers). Acrylic polymers, as used herein, include but are not limited to homopolymers, copolymers, and terpolymers comprising alkyl (meth)acrylates.

Other methacrylate, acrylate, and other vinyl monomers, e.g. vinyl cyanide monomers and acrylonitrile, useful in the monomer mixture include, but are not limited to methyl acrylate, ethyl acrylate and ethyl methacrylate, butyl acrylate and butyl methacrylate, iso-octyl methacrylate and acrylate, lauryl acrylate and lauryl methacrylate, stearyl acrylate and stearyl methacrylate, isobornyl acrylate and methacrylate, methoxy ethyl acrylate and methacrylate, 2-ethoxy ethyl acrylate and methacrylate, and methacrylate monomers, styrene and its derivatives, acrylonitrile, and vinyl cyanides.

Also useful in the preparation of suitable emulsion polymers that can be used in the practice of this invention are functional co-monomers such as acid-functionalized co-monomers, silane-functionalized co-monomers, wet adhesion co-monomers, and crosslinking and crosslinkable co-monomers, including the following non-limiting examples.

Acid-functionalized co-monomers include but are not limited to carboxylic acid-functionalized co-monomers such as (meth)acrylic acid, maleic acid, fumaric acid, itaconic acid, ethacrylic acid, crotonic acid, citraconic acid, cinnamic acid, phthalic acid, isophthalic acid, terephthalic acid, tetrahydrophthalic acid, hexahydrophthalic acid, tetrabromophthalic acid, trimellitic acid, pyromellitic acid, 1,4,5,6,7,7-hexachloro-5-norbornene-2,3-dicarboxylic acid, succinic acid, 2,6-naphthalenedicarboxylic acid, glutaric acid, sebacic acid, azelaic acid, 1,4-cyclohexanedicarboxylic acid, and 1,3-cyclohexanedicarbocylic acid. Preferred examples of carboxylic acid-functionalized co-monomers of this type include acrylic acid, methacrylic acid, itaconic acid. More preferred examples include methacrylic acid and acrylic acid.

A strong acid-functionalized co-monomer selected from phosphorus-based or sulfur-based acid-functionalized monomers or phosphate co-monomers may be used, including non-limiting examples such as: phosphoalkyl (meth)acrylates or acrylates; phospho alkyl (meth)acrylamides or acrylamides; phosphoalkyl crotonates, phosphoalkyl maleates, phosphoalkyl fumarates, phosphodialkyl (meth)acrylates, phosphodialkyl crotonates, vinyl phosphates or (meth)allyl phosphate; phosphate esters of polypropylene glycol mono(meth)acrylate or polyethylene glycol mono(meth)acrylate; polyoxyethylene allyl ether phosphate, or vinyl phosphonic acid. Sulfate-based co-monomers include, without limitation, vinyl- and allyl-sulfonic or sulfuric acids; sulfoethyl (meth)acrylate, aryl-sulfonic or sulfuric acids; (meth)acrylamidoethane-sulfonic or sulfuric acids; methacrylamido-2-methyl propane-sulfonic or sulfuric acids; and the alkali metal salts of sulfonic and sulfuric acids. Preferred examples of such strong acid-functionalized co-monomers include phosphoethyl methacrylate, vinyl sulfonic acid, and 2-acrylamido-2-methylpropyl sulfonic acid.

Nitrogen-containing wet adhesion co-monomers include but are not limited to: ureido (meth)acrylates, (meth)acrylates with at least one of urea and thiourea in the side chains; acrylic allophanes, aminoethyl acrylate and methacrylate; dimethylaminoethyl acrylate and methacrylate; diethylaminoethyl acrylate and methacrylate, dimethylaminopropyl acrylate and methacrylate; 3-dimethylamino-2,2-dimethylpropyl acrylate and methacrylate; 2 N morpholinoethyl acrylate and methacrylate; 2-N-piperidinoethyl acrylate and methacrylate; N-(3-dimethylaminopropyl)acrylamide and -methacrylamide; N-dimethylaminoethylacrylamide and -methacrylamide; N-diethyl aminoethylacrylamide and methacrylamide; N (4 morpholinomethyl)acrylamide and methacrylamide; vinylimidazole and also monoethylenically unsaturated derivatives of ethyleneurea, such as N (2-(meth)acryloyloxyethyl)ethyleneurea, N (β-acrylamidoethyl)ethyleneurea, N 2 (allylcarbamato)aminoethylimidazolidinone, N vinylethyleneurea, N (3 allyloxy-2-hydroxypropyl)aminoethylethyleneurea, N vinyloxyethyleneurea, N methacryloyloxyacetoxyethylethyleneurea, N (acrylamidoethylene)ethyleneurea, N (methacrylamidoethylene)-ethyleneurea, 1 (2 methacryloyloxyethyl)imidazolin-2-one, and N (methacrylamidoethyl)ethyleneurea, N (2 methacrloyloxyethyl) ethylene urea, N (2 methacryloxyacetamidoethyl)-N, N′ ethyl eneurea, allylalkyl ethylene urea, N methacrylamidomethyl urea, N-methacryoyl urea, N- [3-(1,3-diazacryclohexan)-2-on-propyl]methacrylamide, 2-(1-imidazolyl)ethyl methacrylate, 2 (1-imidazolidin-2-on)ethylmethacrylate, N-(methacrylamido)ethyl urea, and allyl ureido wet adhesion co-monomer. A most preferred example of such nitrogen-containing wet adhesion co-monomers is N-(methacrylamidoethyl) ethylene urea.

Other functional co-monomers include, but are not limited to, acrylamide, methacrylamide, acrylonitrile, and vinyl cyanides, vinylpyrrolidone; polypropylene glycol mono(meth)acrylate or polyethylene glycol mono(meth)acrylate; silane-functionalized co-monomers such as methacryloxypropyl trimethoxysilane, methacryloxypropyl triethoxysilane, methacryloxypropyl tripropoxysilane, vinyltrimethoxysilane, and vinyltriethoxysilane; crosslinkers with two or more sites of ethylenic unsaturation, such as ethylene glycol dimethacrylate, diethylene glycol dimethacrylate, trimethylolpropane trimethacrylate, 1,3-butyleneglycol dimethacrylate, and 1,4-butyleneglycol dimethacrylate. Preferred examples of other types of functional co-monomers include acrylamide, acrylonitrile, vinyl trimethoxysilane, vinyl triethoxysilane, and ethylene glycol dimethacrylate,

Crosslinkable co-monomers include the following non-limiting examples: acetoacetate co-monomers containing (meth)acrylate, allyl or vinyl functional groups including but not limited to acetoacetate moieties such as: 2-acetoacetoxyethyl (meth)acrylate, 3-acetoacetoxypropyl (meth)acrylate, 4-acetoacetoxybutyl (meth)acrylate, 2-cyanoacetoxyethyl (meth)acrylate, 3-cyanoacetoxypropyl (meth)acrylate, 4-cyanoacetoxybutyl (meth)acrylate, N-(2-acetoacetoxyethyl) (meth)acrylamide, allyl acetoacetate, 2,3-di(acetoacetoxy)propyl (meth)acrylate, vinyl acetoacetate, and combinations thereof. Also suitable are co-monomers containing a keto group such as diacetone acrylamide. Most preferred of the crosslinkable co-monomers are 2-acetoacetoxyethyl methacrylate and diacetone acrylamide.

Fluoropolymers and copolymers are also suitable to use as the polymer component of the waterborne coating. Non-limiting examples include polyvinylidene fluoride (PVDF) as well as fluoropolymers comprising at least 20 weight percent of one or more fluoromonomers. The term “fluoromonomer” or the expression “fluorinated monomer” means a polymerizable alkene which contains in its structure at least one fluorine atom, fluoroalkyl group, or fluoroalkoxy group whereby those groups are attached to the double bond of the alkene which undergoes polymerization. The term “fluoropolymer” means a polymer formed by the polymerization of at least one fluoromonomer, and it is inclusive of homopolymers and copolymers, and both thermoplastic and thermoset polymers. Useful fluoropolymers for use in the waterborne coating composition include, but are not limited to polyvinylidene fluoride (PVDF), ethylene tetrafluoroethylene (ETFE) polymers, terpolymers of ethylene with tetrafluoroethylene and hexafluoropropylene (EFEP), terpolymers of tetrafluoroethylene-hexafluoropropylene-vinyl fluoride (THV), polyvinylfluoride (PVF), copolymers of vinyl fluoride, and blends of PVDF with functionalized or unfunctionalized polymethyl methacrylate polymers and copolymers. The fluoropolymers may be functionalized or unfunctionalized, and could be homopolymers or copolymers—preferably copolymers with other fluorine monomers, including vinyl fluoride; vinylidene fluoride (VDF); trifluoroethylene (VF3); chlorotrifluoroethylene (CTFE); 1,2-difluoroethylene; tetrafluoro ethylene (TFE); hexafluoropropylene (HFP); perfluoro(alkyl vinyl) ethers, such as perfluoro(methyl vinyl) ether (PMVE), perfluoro(ethyl vinyl) ether (PEVE) and perfluoro(propyl vinyl) ether (PPVE); perfluoro(1,3-dioxole); perfluoro(2,2-dimethyl-1,3-dioxole) (PDD), and blends thereof.

In one embodiment of the invention, the fluoropolymer may be a copolymer of vinylidene fluoride and hexafluoropropylene.

In one embodiment of the invention, the blend of the polymer used in the emulsion or latex could be an intimate blend of two polymers, such as in an acrylic modified fluoropolymer (AMF) in which (meth)acrylate monomers are polymerized in the presence of a fluoropolymer seed.

According to some aspects, the first emulsion polymer a) may comprise, as polymerized units, monomers selected from the group consisting of alkyl (meth)acrylates, C2-C4 olefins, aromatic olefins, conjugated dienes, vinyl monomers, and mixtures thereof. According to certain aspects, the first emulsion polymer a) may comprise, as polymerized units, monomers selected from the group consisting of butyl acrylate, methyl methacrylate, styrene, 2-ethylhexyl acrylate and mixtures thereof. Most preferred monomers used to comprise the first emulsion polymer include butyl acrylate, methyl methacrylate, 2-ethylhexyl acrylate, and styrene. The Tg of the first emulsion polymer a) may be from −60° C. to 40° C., as measured by differential scanning calorimetry.

The amount of the first emulsion polymer a) in the anionically-stabilized aqueous composition may range from 30% to 70% by weight as weight percent of the aqueous composition, or from 40% to 70% by weight as weight percent of the aqueous composition.

In some embodiments, the anionically stabilized aqueous emulsion composition may comprise anionic surfactants or dispersants. Non-limiting examples of suitable anionic surfactants or dispersants may include without limitation salts of fatty rosin and naphthenic acids, condensation products of sulfonic acid and formaldehyde, carboxylic polymers, alkyl sulfates, alkyl aryl sulfonates, and sulfosuccinates. The amount of anionic surfactant or dispersant utilized may range up to 10.0 wt. % based on the weight of the emulsion polymer a). Alternatively, the amount of surfactant used is greater than 0.1 wt. % based on the weight of the emulsion polymer a). When desirable, the amount of anionic surfactant that is utilized is within the range of about 0.1 wt. % to about 5.0 wt. %; alternatively, between about 0.3 wt. % and 4.0 wt. % based on the weight of the emulsion polymer a). Further details regarding an anionically-stabilized latex is provided in U.S. Pat. No. 5,804,627, the entire disclosure of which is hereby incorporated by reference for all purposes. When desirable, the emulsion compositions may also include one or more non-ionic and/or cationic surfactants or dispersants, as well as other additives.

The stability of these anionically-stabilized aqueous emulsion compositions that comprise the polyamine free radical graft copolymers may be evaluated most conveniently by simple observation. Stability means that no large amount of grit formation or solidification due to coagulation takes place upon preparation and storage. After preparation and/or storage, the aqueous emulsion polymer composition is gravity filtered through a fine-mesh filter and the amount of solid found on the filter would give a qualitative indication of relative stability. Excellent stability is represented by no change in the filterable solid after preparation. In some instances, very poor stability is seen by complete solidification of the aqueous emulsion polymer composition.

### Coating Compositions Comprising the Anionically-Stabilized Aqueous Emulsion Polymer Composition

A coating composition may be prepared that comprises the anionically-stabilized aqueous emulsion polymer composition described herein and at least one additional additive. The amount of the polymeric particles comprising the polyamine graft copolymers in the coating composition may range from 0.01 to 10 weight percent of the total dried weight of the aqueous coating composition. The amount of the polymeric particles comprising the polyamine graft copolymers in the coating composition may vary depending on the type and amount of constituents in the coating composition. According to some aspects, the amount of the component c) may comprise, consist of, or consist essentially of, from 0.01 to 5, or from 0.01 to 4, or from 0.01 to 3, or from 0.01 to 2 or from 0.01 to 1 weight percent of the total dried weight of the aqueous coating composition.

The coating composition comprising the anionically-stabilized aqueous emulsion composition may have a pH ranging from 8 to 11, or from 9 to 10.5, or from 9.5 to 10. The coating composition comprising the anionically-stabilized aqueous emulsion composition may be prepared through blending, mixing, or the like, with other additives known to those skilled in the art.

Suitable additives that may be included in the coating composition may be selected from one or more additional polymers, which may or may not be anionically-stabilized, as well as any other known or desired additives. The additional polymer may include, but not be limited to, a polymer or copolymer that is derived from one or more of (meth)acrylate, vinyl aromatic, ethylenically unsaturated aliphatic, or vinyl ester monomers, as well as various combinations thereof. A coating composition comprising the anionically-stabilized aqueous emulsion composition may further or alternately comprise, other known or desired additives such as without limitation, any type of pigments or colorants (including water insoluble metal pigments), fillers, dispersants or surfactants, coalescent agents, pH neutralizing agents, plasticizers, defoamers, thickeners, biocides, co-solvents, rheology modifiers, wetting or spreading agents, leveling agents, conductive additives, adhesion promoters, anti-blocking agents, anti-cratering agents or anti-crawling agents, anti-freezing agents, corrosion inhibitors, anti-static agents, flame retardants, optical brighteners, UV absorbers or other light stabilizers, chelating agents, crosslinking agents, flattening agents, flocculants, humectants, insecticides, lubricants, odorants, oils, waxes or anti-slip aids, soil repellants, or stain resistant agents, as well as mixtures and combinations thereof. The selection of additives incorporated into a coating composition is determined based on a variety of factors, including the nature of the polymer or latex dispersion and the intended use of the coating composition, to name a few.

Several examples of pigments and colorants include, without limitation, metal oxides, such as titanium dioxide, zinc oxide, or iron oxide, as well as organic dyes, or combinations thereof. Examples of fillers may include, but not be limited to, calcium carbonate, nepheline syenite, feldspar, diatomaceous earth, talc, aluminosilicates, silica, alumina, clay, kaolin, mica, pyrophyllite, perlite, baryte, or Wollastonite, and combinations thereof.

Several illustrative examples of co-solvents and plasticizers include ethylene glycol, propylene glycol, diethylene glycol, and combinations thereof, among others. Typical coalescents, which aid in film formation during drying, include but are not limited to, ethylene glycol monomethyl ether, ethylene glycol monobutyl ether, ethylene glycol monoethyl ether acetate, ethylene glycol monobutyl ether acetate, diethylene glycol monobutyl ether, and diethylene glycol monoethyl ether acetate, as well as combinations thereof.

Several illustrative examples of dispersants may include, without limitation, any known surfactants, such as ammonium, alkali metal, alkaline earth metal, and lower alkyl quaternary ammonium salts of sulfosuccinates, higher fatty alcohol sulfates, aryl sulfonates, alkyl sulfonates, alkylaryl sulfonates, alkylphenoxy polyethoxyethanols or ethylene oxide derivatives of long chain carboxylic acids, as well as polyacid dispersants, such as polyacrylic acid or polymethylacrylic acid or salts thereof, and hydrophobic co-polymeric dispersants, such as co-polymers of acrylic acid, methacrylic acid, or maleic acid with hydrophobic monomers.

Several illustrative examples of the thickening agents may include, without limitation, hydrophobically-modified ethylene oxide urethane (HEUR) polymers, hydrophobically-modified alkali soluble emulsion (HASE) polymers, hydrophobically-modified hydroxyethyl celluloses (HMHECs), hydrophobically-modified polyacrylamide, and combinations thereof.

The incorporation of various defoamers, such as, for example, polydimethylsiloxanes (PDMS) or polyether-modified polysiloxanes, may be done to minimize foaming during mixing and/or application of the coating composition. Suitable biocides can be incorporated to inhibit the growth of bacteria and other microbes in the coating composition during storage.

Coatings, which may include, without limitation, paints, adhesives, sealants, caulks, and inks formed from the latex compositions described herein, as well as methods of forming these coatings are believed to be within the scope of the present disclosure. Generally, coatings are formed by applying a coating formulation described herein to a surface, and allowing the coating to dry, during which at least a portion of the volatile base evaporates, to form the coating or film. The resulting dried coatings typically comprise, at minimum, the non-volatile components of the coating composition comprising the anionically-stabilized aqueous emulsion composition as disclosed herein. The coating formulations and/or the dried coatings can further comprise one or more additional polymers and/or additives as described above or known to one skilled in the art. The coating thickness can vary depending upon the application of the coating. The thickness of the coating may be any thickness desirable for use in a particular application; alternatively, the range for the dry thickness of the coating may be between about 0.025 mm (1 mil) to about 2.5 mm (100 mils). The coating formulations can be applied to a variety of different surfaces including, but not limited to metal, asphalt, concrete, stone, ceramic, wood, plastic, polymer, polyurethane foam, glass, and combinations thereof. The coating compositions can be applied to the interior or exterior surfaces of a commercial product or manufactured good or item. When desirable, the surface may be an architectural surface, such as a roof, a wall, a floor, or a combination thereof.

According to one aspect of the present disclosure, each coating formulation may be formulated to meet the requirements for use in a specific application area, including but not limited to, traffic paint, decorative or architectural, pressure sensitive adhesive, deck, “dry-fall”, roof, cementitious, and primer applications, as further highlighted by the following examples. The coating formulation used in each of these applications may be formulated such that it comprises the anionically-stabilized emulsion polymer composition, as previously described above or further defined herein, and optionally, one or more additional polymers or other known or desired additives.

Non-limiting aspects of the invention may be summarized as follows:

Aspect 1: An anionically-stabilized aqueous emulsion composition comprising:

a) a first emulsion polymer present in the aqueous emulsion composition in emulsified form, the first emulsion polymer comprising, as polymerized units, at least one monoethylenically-unsaturated monomer, the first emulsion polymer having a Tg from −60° C. to 40° C.;

b) a volatile base; and

c) a polyamine graft copolymer different from the first emulsion polymer and comprising, as polymerized units, vinyl monomers grafted to a water-soluble amino-group containing polymer;

wherein the anionically-stabilized aqueous emulsion composition has a pH of from 8 to 11, and wherein the c) polyamine graft copolymer is present in an amount effective to de-stabilize the aqueous emulsion composition upon evaporation of at least a portion of the volatile base while maintaining stability of the anionically-stabilized aqueous emulsion composition during preparation and storage.

Aspect 2: The anionically-stabilized aqueous emulsion composition according to Aspect 1, wherein the c) polyamine graft copolymer comprises vinyl monomers free-radical grafted to the amino-group containing polymer.

Aspect 3: The anionically-stabilized aqueous emulsion composition according to either Aspects 1 or 2, wherein the c) polyamine graft copolymers are present in the form of a dispersion and have a particle size of from 50 nm to 400 nm.

Aspect 4: The anionically-stabilized aqueous emulsion composition according to any of Aspects 1-3, wherein the anionically-stabilized aqueous emulsion composition has a pH of from 9 to 10.5.

Aspect 5: The anionically-stabilized aqueous emulsion composition according to any of Aspects 1-4, wherein the c) polyamine graft copolymer is present in the aqueous emulsion composition at a concentration of from 0.01 weight percent to 10.0 weight percent of the total dried weight of the a) first emulsion polymer.

Aspect 6: The anionically-stabilized aqueous emulsion composition according to any of Aspects 1-5, wherein the c) polyamine graft copolymer is present in the composition at from 0.1 weight percent to 5.0 weight percent of the total dried weight of the a) first emulsion polymer.

Aspect 7: The anionically-stabilized aqueous emulsion composition according to any of Aspects 1-6, wherein the c) polyamine graft copolymer is in the form of emulsion polymer particles.

Aspect 8: The anionically-stabilized aqueous emulsion composition according to any of Aspects 1-7, wherein the water-soluble amino-group containing polymer in c) comprises from 0.01 to 5 weight percent of the total dried weight of the anionically-stabilized aqueous emulsion composition.

Aspect 9: The anionically-stabilized aqueous emulsion composition according to any of Aspects 1-8, wherein the c) polyamine free radical graft copolymer comprises from 5 wt. % to 95 wt.% of the vinyl monomers based on the weight of the c) polyamine graft copolymer.

Aspect 10: The anionically-stabilized aqueous emulsion composition according to any of Aspects 1-9, wherein the c) polyamine graft copolymer comprises from 60 wt. % to 90 wt.% of the vinyl monomers based on the weight of the c) polyamine graft copolymer.

Aspect 11: The anionically-stabilized aqueous emulsion composition according to any of Aspects 1-10, wherein the water-soluble amino-group containing polymer in c) comprises polyethylenimine.

Aspect 12: The anionically-stabilized aqueous emulsion composition according to Aspect 11, wherein the polyethylenimine has a Mw from 700 Da to 200,000 Da.

Aspect 13: The anionically-stabilized aqueous emulsion composition according to Aspect 11, wherein the polyethylenimine has a Mw from 2,000 Da to 50,000 Da.

Aspect 14: The anionically-stabilized aqueous emulsion composition according to any of Aspects 11-13, wherein the polyethylenimine comprises branched molecules.

Aspect 15: The anionically-stabilized aqueous emulsion composition according to any of Aspects 1-14, wherein the vinyl monomers in c) are selected from the group consisting of alkyl (meth)acrylates, C2-C4 olefins, aromatic olefins, conjugated dienes, and mixtures thereof.

Aspect 16: The anionically-stabilized aqueous emulsion composition according to any of Aspects 1-15, wherein the vinyl monomers in c) are selected from the group consisting of methyl acrylate, methyl methacrylate, butyl acrylate, butyl methacrylate, styrene, α-methyl styrene, divinyl benzene, butadiene, ethylene, vinyl acetate, vinyl versatate, vinyl chloride, 2-ethylhexyl acrylate, and mixtures thereof.

Aspect 17: The anionically-stabilized aqueous emulsion composition according to any of Aspects 1-16, wherein the volatile base b) is selected from the group consisting of ammonia, trimethylamine, triethylamine, dimethylethanol amine, morpholine, n-methyl morpholine, precursors thereof, and mixtures thereof.

Aspect 18: The anionically-stabilized aqueous emulsion composition according to any of Aspects 1-17, wherein the volatile base b) comprises ammonia.

Aspect 19: The anionically-stabilized aqueous emulsion composition according to any of Aspects 1-18, wherein the first emulsion polymer a) comprises, as polymerized units, monomers selected from the group consisting of alkyl (meth)acrylates, C2-C4 olefins, aromatic olefins, conjugated dienes, vinyl monomers, and mixtures thereof.

Aspect 20: The anionically-stabilized aqueous emulsion composition according to any of Aspects 1-19, wherein the first emulsion polymer a) comprises, as polymerized units, monomers selected from the group consisting of butyl acrylate, methyl methacrylate, styrene, 2-ethylhexyl acrylate, vinyl acetate and mixtures thereof.

Aspect 21: An aqueous coating composition comprising the anionically-stabilized aqueous emulsion composition according to any of Aspects 1-20, and d) a water insoluble metal pigment.

Aspect 22: The aqueous coating composition according to Aspect 20, wherein the aqueous coating composition has a pH of from 8 to 10.5.

Aspect 23: The aqueous coating composition according to either Aspect 21 or Aspect 22, wherein the component c) comprises from 0.01 to 5.0 weight percent of the total dried weight of the aqueous coating composition.

### EXAMPLES

### General Test Procedures:

Dry Time Test: This test is similar to ASTM D1640, a standard test for determining drying time of organic coatings at room temperature. The test films are applied on a non-porous substrate (glass plate or metal panel) by suitable means to give a wet film thickness of 0.012±0.001 inches (0.031±0.003 cm). Evaluation of the fast-setting performance is carried out by testing tack-free time and dry-through time. Tack-free time is defined as the time after initial coating application at which the coating does not adhere to a gloved finger when touched with light pressure. Dry-though time is defined as the time after initial coating application at which the coating does not break when light pressure and 90° twisting from a gloved finger is carried out. The ASTM test method is modified in that only minimal finger pressure is used. The gloved finger is turned through an angle of 90° while in contact with the coating film. The drying time at which this rotation does not break the film is recorded as the dry-through time.

### Example 1: Exemplary Method of making the Vinyl Grafted Polyamine Copolymers

A method of making these polymers is described in U.S. Patent No. 6,573,313 B2, the entire contents of which are incorporated by reference herein for all purposes.

### Example 1A: 4:1 Ratio by Weight of Methyl Methacrylate Grafted to Polyethylenimine (PEI)

The polyamine graft copolymer was prepared in a jacketed, 1 gallon reaction flask. 30 grams of Lupasol® WF (BASF) polyethylenimine were dissolved in 620 grams of deionized water and added to the jacketed reactor. The reactor was then purged with nitrogen gas for 10 minutes. 120 grams of methyl methacrylate was then charged to the reactor. The contents of the reactor were then agitated for 5 minutes at 200 rpm. The reactor temperature was then adjusted to 80° C. 7.50 grams of tert-butyl hydroperoxide was then charged to the reactor. The reactor contents were then held at 80° C. for 2 hours. After 2 hours the reactor contents were cooled down to ambient temperature and transferred for storage. The solids content of the resulting graft copolymer was 22.9% and the particle size was 160 nm.

### Example 1B: Example 1B=1.83:2.17:1 Ratio of butyl Acrylate/Methyl Methacrylate Grafted to Polyethylenimine

The polyamine graft copolymer was prepared in a jacketed, 1 gallon reaction flask. 30 grams of Lupasol® WF (BASF) polyethylenimine was dissolved in 620 grams of deionized water and added to the jacketed reactor. The reactor was then purged with nitrogen gas for 10 minutes. A neat monomer mixture was prepared by mixing 65 grams of methyl methacrylate and 55 grams of butyl acrylate. The neat monomer mixture was then charged to the reactor. The contents of the reactor were then agitated for 5 minutes at 200 rpm. The reactor temperature was then adjusted to 80° C. 7.50 grams of tert-butyl hydroperoxide was then charged to the reactor. The reactor contents were then held at 80° C. for 2 hours. After 2 hours the reactor contents were cooled down to ambient temperature and transferred for storage. The solids content of the resulting graft copolymer was 21.8% and the particle size was 98 nm.

### Example 2: Preparation, Dry Time, Dry Through Time and Stability of Coating Compositions

Into an aqueous emulsion composition (Encores 636, Arkema) adjusted to pH 9 with aqueous ammonium hydroxide (ammonia in water) was added dropwise the polyamine free radical graft copolymer of Example 1 at a level of 2 wt. % of the dry weight of the first emulsion polymer a). This pH was enough to maintain colloidal stability, thus forming an anionically-stabilized aqueous emulsion composition according to the invention.

Comparative examples were prepared the same way, except that 0.4 wt % and 2 wt % of ungrafted polyethylenimine (PEI, Lupasol® WF, BASF) was used instead of the Example 1 polyamine free radical graft copolymers. Another comparative sample was prepared without either of the polyamine free radical graft copolymer or the ungrafted PEI.

Table 1 below outlines both the improved stability and retention of fast-dry behavior of an aqueous emulsion polymer composition comprising an anionically stabilized emulsion polymer, a volatile base, and polyamine free radical graft copolymer as compared to similar compositions containing conventional, unmodified polyamines (0.4% and 2.0% Lupasol® WF).

TABLE 1
Example 2 Results

| | | | Tack free | Dry through | Tack free | Dry through |
|---|---|---|---|---|---|---|
| Additive to | Stability 25° C. | | time | time | time | time |
| Encor ® 636 | pH 9.0 | pH 10.0 | pH 9.0 | | pH 10.0 | |
| None | Stable | Stable | >>20 min. | >>20 min. | >>20 min. | >>20 min. |
| 0.4 *weight | Grit while | Grit while | — | — | — | — |
| % PEI | preparing; | preparing; | | | | |
| | 20-50% | 20-50% | | | | |
| | coagulation | coagulation | | | | |
| | after 8 | after 8 | | | | |
| | hours | hours | | | | |
| 2 *weight | Coagulated | Coagulated | — | — | — | — |
| % PEI | while | while | | | | |
| | preparing | preparing | | | | |
| 2 *weight | Slight grit | Stable | 13 min. | 15 min. | 8 min. | 10 min. |
| % Example | but stable | | | | | |
| 1A | | | | | | |
| 2 *weight | Stable | Stable | >20 min. | >>20 min. | 6 min. | 8 min. |
| % Example | | | | | | |
| 1B | | | | | | |

*weight % based on the dried weight of the first emulsion polymer a).

Table 1 illustrates that the addition of both low and relatively higher levels of ungrafted polyethyleneimine to pH-adjusted aqueous emulsion composition results in poor stability, as evident by the grit generated upon preparation (as in the case of 0.4 weight % ungrafted PEI) and coagulation upon preparation (as in the case of 2 weight % ungrafted PEI). The polyamine free radical graft copolymer, on the other hand, generates more stable aqueous emulsion compositions and exhibits fast-setting performance under the specified pH conditions.

Within this specification embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

1. An anionicaily-stabilized aqueous emulsion composition comprising:
a) a first emulsion polymer present in the aqueous emulsion composition in emulsified form, the first emulsion polymer comprising, as polymerized units, at least one monoethylenically-unsaturated monomer, the first emulsion polymer having a Tg from −60° C. to 40° C.;
b) a volatile base; and
c) a polyamine graft copolymer different from the first emulsion polymer and comprising, as polymerized units, vinyl monomers grafted to a water-soluble amino-group containing polymer;
wherein the anionically-stabilized aqueous emulsion composition has a pH of from 8 to 11, and wherein the c) polyamine graft copolymer is present in an amount effective to de-stabilize the aqueous emulsion composition upon evaporation of at least a portion of the volatile base while maintaining stability of the anionically-stabilized aqueous emulsion composition during preparation and storage.

2. The anionically-stabilized aqueous emulsion composition according to claim 1, wherein the e) polyamine graft copolymer comprises vinyl monomers free-radical grafted to the amino-group containing polymer.

3. The anionically-stabilized aqueous emulsion composition according to claim 1, wherein the c) polyamine graft copolymers are present in the form of a dispersion and have a particle size of from 50 nm to 400 nm.

4. The anionically-stabilized aqueous emulsion composition according to claim 1, Wherein the anionically-stabilized aqueous emulsion composition has a pH of from 9 to 10.5.

5. The anionically-stabilized aqueous emulsion composition according to claim 1, wherein the c) polyamine graft copolymer is present in the aqueous emulsion composition at a concentration of from 0.01 weight percent to 10.0 weight percent of the total dried weight of the a) first emulsion polymer.

6. The anionically-stabilized aqueous emulsion composition according to claim 1, wherein the c) polyamine graft copolymer is present in the composition at from 0.1 weight percent to 5.0 weight percent of the total dried weight of the a) first emulsion polymer.

7. The anionically-stabilized aqueous emulsion composition according to claim 1, wherein the c) polyamine graft copolymer is in the form of emulsion polymer particles.

8. The anionically-stabilized aqueous emulsion composition according to claim 1, wherein the water-soluble amino-group containing polymer in c) comprises from 0.01 to 5 weight percent of the total dried weight of the anionically-stabilized aqueous emulsion composition.

9. The anionically-stabilized aqueous emulsion composition according to claim 1, wherein the c) polyamine free radical graft copolymer comprises from 5 wt. % to 95 wt. % of the vinyl monomers based on the weight of the c) polyamine graft copolymer.

10. The anionically-stabilized aqueous emulsion composition according to claim 1, wherein the c) polyamine graft copolymer comprises from 60 wt. % to 90 wt. % of the vinyl monomers based on the weight of the c) polyamine graft copolymer.

11. The anionically-stabilized aqueous emulsion composition according to claim 1, wherein the water-soluble amino-group containing polymer in c) comprises polyethylenimine.

12. The anionically-stabilized aqueous emulsion composition according to claim 11, wherein the polyethylenimine has a Mw from 700 Da to 200,000 Da, preferably from 2,000 to 200,000 Da.

13. The anionically-stabilized aqueous emulsion composition according to claim 11, wherein the polyethylenimine has a Mw from 2,000 Da to 50,000 Da.

14. The anionically-stabilized aqueous emulsion composition according to claim 11, wherein the polyethylenimine comprises branched molecules.

15. The anionically-stabilized aqueous emulsion composition according to claim 1, wherein the vinyl monomers in c) are selected from the group consisting of alkyl (meth)acryiates, C2-C4 olefins, aromatic olefins, conjugated dienes, and mixtures thereof.

16. The anionically-stabilized aqueous emulsion composition according to claim 15, wherein the vinyl monomers in c) are selected from the group consisting of methyl acrylate, methyl methacrylate, butyl acrylate, butyl methacrylate, styrene, α-methyl styrene, divinyl benzene, butadiene, ethylene, vinyl acetate, vinyl versatate, vinyl chloride, 2-ethylhexyl acrylate, and mixtures thereof.

17. The anionically-stabilized aqueous emulsion composition according to claim 1, wherein the volatile base b) is selected from the group consisting of ammonia, trimethylamine, triethylarnine, dimethylethanol amine, morpholine, n-methyl morpholine, precursors thereof, and mixtures thereof.

18. The anionically-stabilized aqueous emulsion composition according to claim 1, wherein the volatile base b) comprises ammonia.

19. The anionically-stabilized aqueous emulsion composition according to claim 1, wherein the first emulsion polymer a) comprises, as polymerized units, monomers selected from the group consisting of alkyl (meth)acrylates, C2-C4 olefins, aromatic olefins, conjugated dienes, vinyl monomers, and mixtures thereof.

20. The anionically-stabilized aqueous emulsion composition according to claim 1, wherein the first emulsion polymer a) comprises, as polymerized units, monomers selected from the group consisting of butyl acrylate, methyl methacrylate, styrene, 2-ethylhexyl acrylate, vinyl acetate and mixtures thereof.

21. An aqueous coating composition comprising the anionically-stabilized aqueous emulsion composition according to claim 1, and d) a water insoluble metal pigment.

22. The aqueous coating composition according to claim 20, wherein the aqueous coating composition has a pH of from 8 to 10.5.

23. The aqueous coating composition according to claim 21, wherein the component c) comprises from 0.01 to 5 weight percent of the total dried weight of the aqueous coating composition.
